(19) United States
(12) Patent Application Publication
(10) Pub. No.: US 2013/0044200 A1
(43) Pub. Date: Feb. 21, 2013

(54) SYSTEM AND APPARATUS FOR THE CALIBRATION AND MANAGEMENT OF COLOR IN MICROSCOPE SLIDES

(71) Applicants: Michael H. Brill, Kingston, NJ (US); Hong Wei, Lawrenceville, NJ (US); Taeyoung Park, Princeton, NJ (US)

(72) Inventors: Michael H. Brill, Kingston, NJ (US); Hong Wei, Lawrenceville, NJ (US); Taeyoung Park, Princeton, NJ (US)

(73) Assignee: Datacolor, Inc., Lawrenceville, NJ (US)

(21) Appl. No.: 13/211,875

(22) Filed: Aug. 17, 2011

(51) Int. Cl. H04N 7/18; G06K 9/00

(52) U.S. Cl. 348/79; 382/167; 348/E07.085

(57) ABSTRACT

A system and apparatus for the color calibration of images recorded through a microscope. An integrated color calibration target microscope slide device and specimen are recorded with an imaging device that acquires both the color values of the specimen and the color values of the color calibration target under a plurality of illuminations and trans-illuminations. A composite image is formed to provide a spectral estimation of the relevant color values of the image. The image is converted into multi-stimulus values governed by a plurality of illuminating conditions. The multi-stimulus values are used to provide image calibration data so that color values of the image, when displayed on a display devices, are faithfully reproduced.

### FIELD OF THE INVENTION

The present invention relates to a color management system for use with images of microscopic samples, and, more particularly, to an apparatus that uses microscopic samples to standardize the colors displayed therein in furtherance of color transformation from one system (e.g., a microscope image captured by an image capture device) to another (e.g., an image on a display screen) so as to accurately and consistently portray the colors in a third system (e.g., the above microscope image directly viewed by a human).

### BACKGROUND OF THE INVENTION

Currently, digital imaging has allowed for unprecedented levels of collaboration between technicians, researchers, and scientists. In part, this collaboration is due to the relatively inexpensive nature of current digital imaging technology. Image capture devices and associated software platforms combined with improved computer screens and monitors have also allowed for the rapid analysis and review of images where accurate color fidelity is essential. The proliferation of different style, models and technical complexity of digital imaging technology can be readily seen in the digital microscopy market. In the field of digital imaging, there are many microscope systems that provide custom digital images. Unfortunately, there is no standard or method currently available that ensures color accuracy and consistency from one system to another. In fact, the color characteristics and value ranges of one brand of computer display can differ even between identical computer displays. This poses a problem for all industries that rely on accurate color representation. This is of paramount importance in scientific research endeavors that use and disseminate digital images. Specifically, the field of digital microscopy is in need of a system to ensure that different researchers receive accurate color information when they receive digital images of slides.

Due to differing models and technical sophistication in microscope image capture devices; there is no current way to ensure that the color data recorded in one image is the same as subsequent images. Additionally, there are a wide variety of microscope adaptors available that allow standard high resolution imagers to be coupled to existing microscope systems. As a result, almost any consumer level digital imaging device can be coupled to a microscope. Without knowing the settings on each individual camera, it becomes difficult to standardize the color values in the image.

What is needed is a system that simplifies and standardizes the color capture values from differing image capture sources and provides sufficient parameter information regarding color so as to allow a recipient of data to ensure that the color values displayed are a true representation of the color values recorded. What is further needed is a system that allows for the recordation of color calibration values while taking pictures of samples on a microscope slide. What is also needed is a system that produces images of microscope slides that have color ranges as close as technically possible to the range perceived by the human eye. This system should include a calibrated array of master color values for a variety of lighting and illumination conditions. Lastly, what is needed is a microscope slide that can assist a user in configuring the color values of their system so as to provide intra-system agreement. The subject invention is addressed to these deficiencies in the art.

### SUMMARY OF THE INVENTION

In accordance with the broad aspects of the present invention, the apparatus disclosed herein provides for the calibration of color and the analysis of microscope samples. In more particular aspects, the present invention provides for an integrated color calibration microscope slide. In part, the present invention enables a technical researcher, medical professional, clinician, aid worker, or other member of the scientific community to capture and distribute images of a microscope sample in a way that ensures that all recipients of the image are enabled to perform proper color calibrations.

The present invention enables, in part, the individual researchers to have a color target impregnated microscope slide for use in typical microscopy work. A system and method according to the invention can be configured to enable the individual to record a sequence of images with a camera that acquires a digital image of a specimen under a plurality of lighting conditions. In the present invention, the specimen and the integrated color reference target are recorded in the same image or series of images. Furthermore, these images are the result of illumination or trans-illumination by a series of illuminants in different spectrums. The resulting images can be captured by any imaging camera that has been purposefully built or specially adapted to work in conjunction with a microscope. Because the reference spectrum of any image is known, a standardized value can be achieved for each color target parameter.

The present invention, in a further aspect, can provide a series of filters or filtered sub-images that form a composite image which provides information regarding different transmission spectra. Through this compositing or filtering, the transmitted or reflected light spectrum at every pixel of the image, including pixels that comprise reference sub-images can be discerned. These pixels can be used to provide a spectral estimation of the relevant color values in the image. This image can be converted into multi-stimulus values governed by a plurality of illuminating conditions (including a single illuminant directed through one of a plurality of spatially uniform filters). In this manner, the present invention allows the recipient of the image to have a suitable data within the image so as to calibrate the color values on a different display device. These images can then be analyzed under normal methods as though they were being looked at through the microscope directly.

### BRIEF DESCRIPTION OF THE DRAWINGS

FIG. 1 is an illustrative diagram of a microscope as known and used in the prior art.

FIG. 2 is an illustrative diagram of a microscope slide and integrated color targeting mechanism in accordance with one embodiment of the invention;

FIG. 3 is an illustrative diagram of the operations of a fluorescence microscope;

FIG. 4A is an illustrative diagram of the field of capture of an imaging device when used to capture images employing a method in accordance with one embodiment of the invention;

FIG. 4B is an illustrative diagram of the field of capture of an imaging device when used to capture images employing a method in accordance with an alternative embodiment of the invention;

FIG. 5 is an illustrative diagram of an illumination configuration that can be employed in an embodiment of the present invention;

FIG. 6 is an illustrative side view of an illumination configuration that can be employed in an embodiment of the present invention; and

FIG. 7 is a block diagram showing components that can be used in a preferred embodiment of the present invention.

### DESCRIPTION OF ILLUSTRATIVE CERTAIN EMBODIMENTS OF THE INVENTION

By way of overview and introduction, the present invention concerns a system and apparatus for the calibration of color values represented within a digital image and providing sufficient color information so as to accurately reproduce those values on any number of image display devices. The system provides a solution to scientists and other technical professionals that enable them to obtain a chromatically accurate analysis of slide specimens and to rapidly disseminate their findings and images together with information that enables the color values to be maintained. As well, the present invention allows for the colors of the image to be faithfully represented so that an observer of the image on a display sees the same colors as a person viewing the slide directly through the microscope.

The microscope used in connection with the present invention relates to those devices in which light forms images by transmission through lenses, and not by reflection from mirrors. Those skilled in the art would readily appreciate those modifications and inherent characteristics of such mirror-based devices and how they are applicable to the present invention.

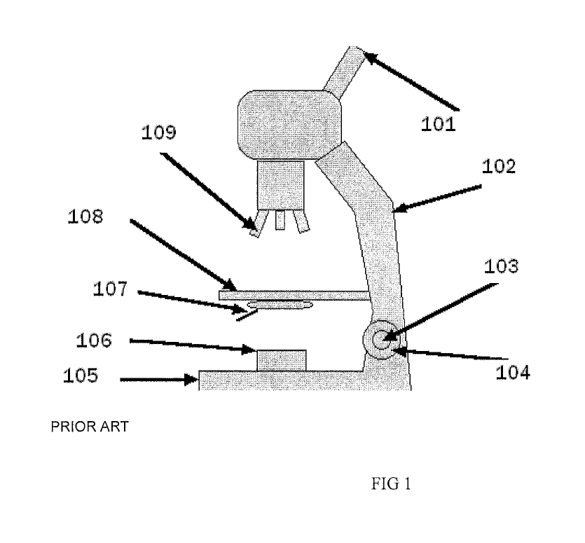

As seen in FIG. 1, the present invention is applicable to, and can be used in conjunction with, multiple types of microscopes. For example, the present invention, in a particular embodiment, can employ the use of a transmission microscope. A transmission microscope is a device or apparatus in which the light source and the viewer are on opposite sides of the plane of the slide/specimen, and in which transmitted light is passed through the specimen. The light transmitted to the camera is a product of the incident illumination and the transmittance spectrum of the specimen. In this embodiment the elements of the microscope include an eyepiece 101, and arm 102 a fine and coarse focus knobs 103/104, a base, an illumination source 106, a diaphragm 107, a stage 108 and objective lenses. In an alternate embodiment, a reflection microscope can be employed. Light source and the viewer are on the same side of the plane of the slide/specimen, and reflected light is returned from the specimen. In this embodiment, the light transmitted to the camera is a product of the incident illumination and the reflectance spectrum of the specimen. Both transmission and reflection microscopes pose the same formal problem of finding the specimen's physical color (reflectance or transmittance) from the three camera values (R, G, B) of the light returned to the camera (which contains the illuminant spectrum as a factor).

In another embodiment of the present invention, a fluorescent microscope can be employed in which the light source and the viewer are on the same side of the plane of the slide/specimen, and the system uses fluorescent visible light due to the incident-beam UV excitation is returned from the specimen. The light transmitted to the camera is in this case itself the signature of the specimen, and depends on the intensity of the incident UV radiation and not on the relative spectrum of the light. Unlike transmission and reflection microscopes, the fluorescent microscope poses the simpler problem of finding the specimen's fluorescent emission spectrum from three camera values (R, G, B) of the light returned to the camera (which contains only the illuminant intensity as a factor).

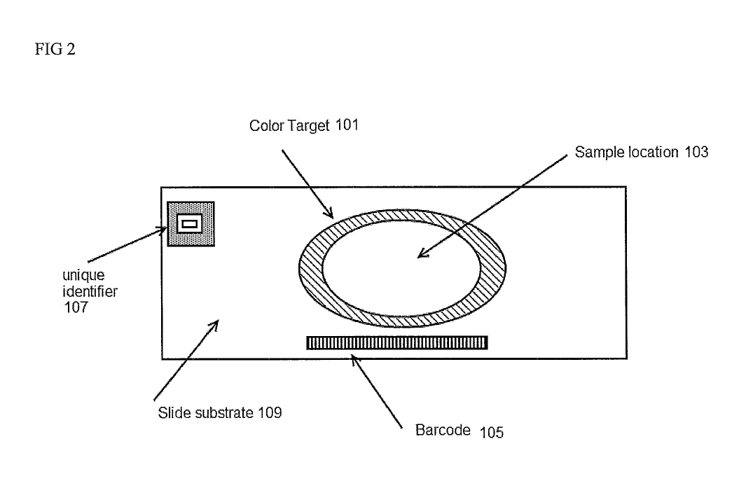

As seen in FIG. 2, an embodiment of the present invention provides a specimen slide 109 (slide substrate) containing a composite target area 101 of known transmittance colors. This color calibration target 101 is positioned so that it is available to be directly illuminated. The color target 101 is further configured to be located so that images taken of the sample can also include a portion of the color target 101. The color target can be a color wheel or any geometric shape. Further, the color target can contain a plurality of parts with different transmission or reflectance spectra necessary to replicate the complete range of transmission or reflectance spectra likely to appear in the slide image. In one embodiment of the present invention, the color target is printed onto the substrate 109 by means of a printer. The color target can be printed on the slide using standard photolithography techniques. The color target 101 contains a plurality of different colors that produce different spectrum emissions depending on the illumination. The specific characteristics of the illuminant that produces a particular emission spectrum are known and stored within a database accessible by the present invention. The reflectance or transmittance spectra of the calibration targets must be known. The spectra of the actual microscope illuminants, either filtered or unfiltered need not be known according to one aspect of the invention. The spectra of the presentation illuminants (which are part of the displayed simulation of the slide) can be known. If the spectra illuminants are forced to be the same as the microscope illuminants, then the microscope illuminant spectra are known too. The present invention provides for a particular embodiment wherein the two illuminants are the same. In an alternative embodiment, the illuminants are not identical.

While the color target 101 is depicted within the center of the slide 109, it is possible that the color target can be located on any portion of the slide that is visible to an imaging device. The slide substrate 109 can comprise a standard microscope or optical slide known to the art. The slide 109 can be composed of glass, steel, plastics, composite materials, and other standard materials used for slide production. In a particular embodiment of the present invention, the transparent slide materials are selected from those materials commonly used as slide material in transmission microscopy. In an alternate embodiment, the transparent slide material is selected from those slide materials commonly used for reflection microscopy. The slide 109 can be formed of material suitable for photolithography. Such photolithography based slides can be composed of materials that are suitable and are commonly used in the art for photolithography techniques.

The slide 109 can optionally further incorporate data enhancements that are capable of providing information to an end user. For example, the slide can incorporate visual unique source and serial numbers such as bar 105 codes, q-codes 107, visual and graphical unique identifier images, and embedded RFID tags.

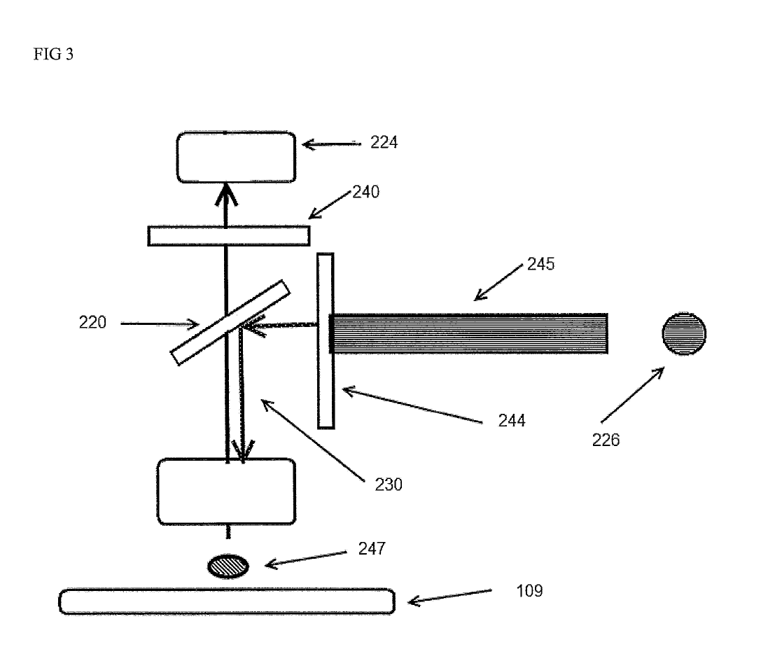

In an embodiment relating to fluorescence microscopy, as seen in FIG. 3, quantum dots 202 can be used for spectral sensitivity calibration for the various imaging devices in conjunction with, or in alternative to, the printed color target. A fluorescence microscope, whose operation has been simplified for inclusion in FIG. 3, operates using reflecting geometry. In operation, UV light 230 from a light source 226 is filter by an excitation filter 244 form the remaining spectrum 245 so that it alone is incident on a dichroic prism 220 and the dichroic reflects part of the light down through the optics of the microscope to the specimen where it excites fluorescence in the specimen 247. The fluoresced visible light passes back through the same optical path and some of that light passes through the dichroic prism and an emission filter 240 to the detector 224. In an alternative embodiment, a reflecting microscope is used. In that embodiment, the light paths depicted in FIG. 3 are the same for light paths in a reflecting microscope. However, it should be noted that in a reflecting microscope UV light 230 will be, in actuality, be replaced by light at visible wavelengths. Furthermore, while the fluorescent microscope depicted in FIG. 3 allows for UV light to be transmitted by optical elements, those embodiments employing reflecting microscopes see UV light blocked by optical elements. As such, in those embodiments employing reflecting microscopes, a half-silvered mirror can be used, instead of the prism 220.

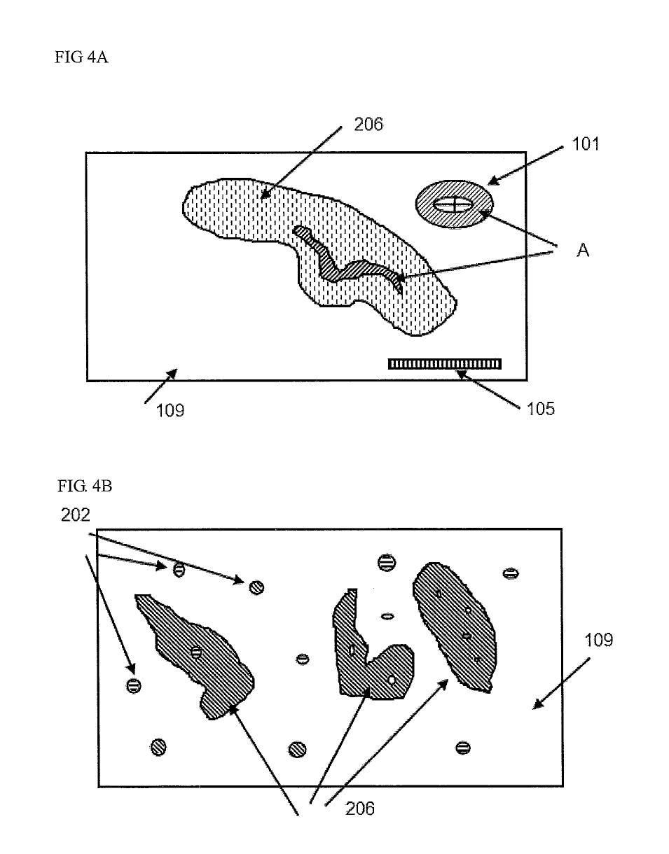

The present invention, when employing the use of quantum dots, can use quantum dots with varying characteristics, As seen in FIGS. 4A-B, the present invention employs the use of variable particle size quantum dots 202 that, that when exposed to ultraviolet (UV) illumination, emit a peak of light energy corresponding to a wavelength that is proportional to the particle size of the quantum dot 202. In this way, it is possible to use a plurality of different sized quantum dot particles to provide a color palette 204 for quantum dots. For example, a palette of different particle sized quantum dots can be arrayed on the substrate 109 on a slide next to or coextensive with a specimen.

In this embodiment, it is possible that the quantum dots 202 can be used to stain a biological specimen 206 placed on the slide. Both the substrate 109 and the specimen 206 are then illuminated by light energy, for example by 350 nm UV light, in a manner that insures that there is uniformity in the illumination. In this way, a properly configured imaging device can view the portions of the slide having both the reference quantum dots and the stained biological sample, for example investigations inside the cellular boundaries of an organism. The present invention also includes a system for the capture and processing of the integrated slides. The imaging system can be capable of recording images having at least three (3) independent color channels (tri-chromatic characteristics). The invention can allow for the usage of an existing camera having at least these minimum specifications.

In an alternative embodiment, the imaging system of the present invention incorporates at least 3 broad band filters configured to transmit different spectral bands of light. These filters are optionally configured to interpose themselves between the specimen stage and the imaging device. Thus, the present invention is configured to provide a series of filtered images that further augment the spectral information obtainable from the color channels available to the imaging device. It has been found that three such filters, in conjunction with three color sensors in the imaging device give sufficient accuracy in the reconstructed color image. Those skilled in the art appreciate that the relationship between the number of images and the number of colors in the vision and color components is not intrinsically linked. The present invention is not limited to any specific intrinsic connection.

As discussed above, the present invention allows images of samples to be color calibrated based on multiple images of the samples captured under different reference illumination conditions. In an embodiment of the present invention, this calibration involves estimating the tristimulus values of a sample's reflectance (or transmittance) under three illuminants, as determined from the RGB camera values and from the RGB camera values of a simultaneously-imaged chart of calibration samples such as the color target or quantum dots integral on a specimen slide. This can be accomplished because the color calibration data received is from a source that is illuminated under the same light sources as the sample being analyzed, but with predetermined and known color values.

As seen in FIG. 4A, a biological specimen 206 is placed on the substrate slide 109 and illuminated. As can been seen in the field of view, the color calibration target 101 is visible within the same frame as the biological sample 206. This ensures that the correct calibration processes are preformed on the colors located within the sample. For example the colors within the target have the same spectral characteristics those found within a portion of the biological sample (A). In the present invention, knowledge of the calibrated values found within the color target 101 allows the determination of the correct chromatic values for the biological sample 206.

In the alternative, as seen in FIG. 4B, the biological sample 206 is co-located on the substrate 109 with a plurality of quantum dots 202 of known characteristics. As stated above, the quantum dots 202, upon illumination, will emit specific wavelengths that correspond to their dimensions. Furthermore, as described above, the quantum dots can be used to stain the biological samples 206, from which the colors can be calibrated by using groups of dots of the same color as reference color targets.

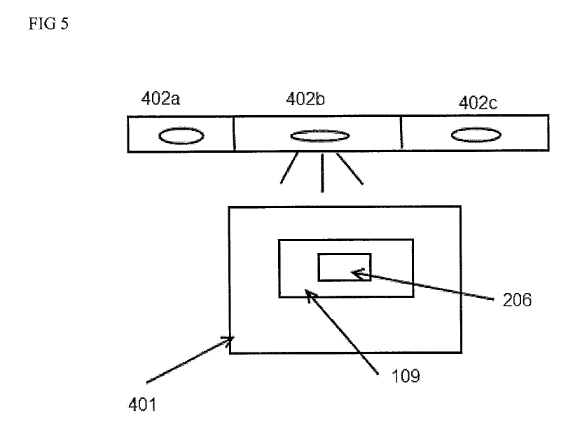

In any of these embodiments, a servo-mechanism that moves the microscope stage can bring the reference colors and the biological specimen alternatively into view when the imaging takes place at a magnification level where the color target is no longer in the field of view, Once the microscope has been prepared with a sample, and possibly stained with quantum dots, it is secured on the microscope stage. As shown in FIG. 5, the microscope stage 401 is designed to position the slide under a plurality of light sources 402A-C. The light sources are able to be shifted or rotated so that a single illumination point 402A, 402B or 402C is used to illuminate the sample. When a series of illuminations is necessary, the light sources, and/or a separate plurality of filters, are rotated or otherwise shifted into the same operative place in the microscope as a previous illumination source. In this manner, no colored shadows are produced by the multiple exposures that would complicate computational functions of the present invention. Alternatively, the present invention provides for a single light source with changeable filters either at the light source or elsewhere in the optical path). In a preferred embodiment, the present invention does not employ the use of multiple concurrent illumination sources.

The illumination sources and filter (or alternatively, sources with multiple interchangeable filters) provide the ability to emit specific spectra of light. While it is indicated that the sources of illumination are separate from the slide, this is done for the sake of clarity. Those skilled in the art would appreciate that the illumination sources can be integral to the slide or positions as a separate element of the invention.

Each of the illumination sources, wherein each source is used at one time can provide a steady source of specific spectrum of illumination, such as ultra violet, infrared, daylight (CIE standard D65), tungsten light, fluorescent light, or other specific visible light frequencies. Further, the light sources 402A-C are positioned such that the reference illuminations emitted by the light sources are incident upon the microscope stage and the slide itself. In an alternative embodiment these light sources can be actively filtered so as to produce specific illumination characteristics.

In the alternative configuration, the illumination source(s) are configured to have a filter, or a plurality of filters, interspaced between the microscope slide and the image recording device. This configuration is suitable for use with a light box and similar apparatuses. A light box allows for a smaller filter to be used, since the required filter need only cover the camera lens, and the not light source. Additionally, this configuration allows for delicate and thermally sensitive filters to be placed away from an illumination source.

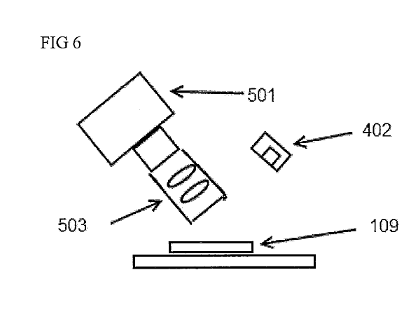

As seen in FIG. 6 an imaging device 501 is coupled to magnification elements 503 necessary to view the specimens 206 on the slide 109 at proper magnification. The imaging device is configured to be a digital imaging device that is capable of taking still images of the specimen with sufficient resolution. The imaging device 501 is further configured to take a series of images. Each image in the series corresponds to a different lighting condition or spectrum as provided by the light sources 402. In the alternative, a series of removable filters can be attached to the digital imaging device to as to provide the necessary series of illuminant filters. This series of images can then be calibrated, using the known spectral characteristics of the illumination source of each image in the series. Further, each slide, through use of its unique identifier, can provide access to a database indicating the precise color values for each portion or region of the color palette or color target.

The combination of known spectral color values of the integral color targets of the slides and the characteristics of the illuminants provides sufficient chromatic information so as to calibrate the color of each pixel in the images according to preset requirements for transmittal to a visual display device. In order to accurately display the resulting calibrated pixels, each image must be corrected. Image correction takes place after the recording of an image, usually at a time soon after the original image was taken. In a preferred embodiment the image correction is processed by a local computer immediately after the image is taken. Image correction involves physically inserting a spatially uniform gray target (for a reflecting microscope), a uniformly fluorescing target (for a fluorescent microscope), or a blank slide (for a transmitting microscope); and measuring the pixel values P₀(i, j) in each color channel. This is done preferably with the same imaging device that was used to record the original image. These values are then used to correct the values in the original image.

Determining the correct values for the images is a known process. It is well known in the art the process of color calibration of pixels that converts camera values to tristimulus values. For example in one embodiment (applying to the reflection microscope, but applicable also to a transmission microscope by replacing reflectance by transmittance in the mathematics), the tristimulus values of the reflectance under the three reference illuminants (column 9-vector r) are estimated from the reflectance's measured camera RGB values under the same three illuminants (column 9-vector d) in conjunction with a number K of simultaneously acquired calibration samples whose pre-measured reflectance spectra are used to compute tristimulus values that are stored in a database. A further feature of the present invention is that the reference illuminants do not require the same spectra as the actual microscope illuminants in order for the present apparatus to function.

The calibration values in this case comprise a 9×K matrix D of camera values ( generated from 3 values under each of 3 light sources) from the calibration chart and a 9×K matrix R_{T} of tristimulus values from the same calibration chart, where K is the number of reflectances. For example, a color chart having K=24 reflectances may be used. The matrix D from the calibration chart is measured by the camera under the same illuminants, and at the same times, as is an image of test reflectances. The matrix R_{T} is pre-computed from the reflectance values pre-measured from the calibration chart, in conjunction with color matching functions and three reference-illuminant spectra.

To calibrate, a 9×9 matrix M and an offset vector b are computed so as to estimate the tristimulus 9-vector r of any test reflectance. The matrix M and offset vector b map (as closely as possible) all of the database camera value 9-vectors to corresponding tristimulus 9-vectors as follows:

R_{T}=MD+b (EQN. 1)

EQN. 1 may be represented as a homogeneous equation as:

R_{T}=M_{A}D_{A} (EQN. 2)

where M_{A}=[M b] is the 9×10 matrix comprising M right-augmented by the column vector b, and D_{A}=[D′1′]′ is the 10×9 matrix comprising D augmented from the bottom by a row K-vector 1 of 1's. Here, D′ is the transpose of D. To estimate M_{A}, the following least-square approximation is used:

M_{A}R_{T}pinv(D_{A})=R_{T}D_{A}′(D_{A}D_{A}′)⁻¹ (EQN. 3)

In an alternative embodiment, a 3×K matrix stores the data for each illuminant handled separately. The 3×3 calibration matrix M is calculated separately for each illuminant, and each image is corrected using the corresponding M matrix.

Once calibration is performed as set forth above, a new tristimulus 9-vector rₐ is computed for each pixel from its measured camera 10-vector d_{A} (the column vector d extended by 1 in the tenth component), as:

rₐ=M_{A}D_{A} (EQN. 4)

After retrieving the required sets of tristimulus values, one can convert the XYZ values to screen RGB values using conventional color management techniques based on International Color Consortium (ICC) profiles. For example, the techniques described by Morovic in “Color Gamut Mapping” (Colour Engineering: Achieving Device Independent Colour, Chapter 13, pp. 297-317, Wiley 2002) may be used. These steps result in a complete transformation between camera values under three illuminants and displayed tristimulus values under another three illuminants.

In one embodiment of the above, the number of calibration database reflectances is K=24. This represents the number of color samples used for calibration. In practice, one may have more than twenty-four samples. In one embodiment, the reflectance values fall in a range from zero to one.

r is a column 9-vector, where r(1) is the R value of reflectance under camera illuminant 1; r(2) is the G value of reflectance under camera illuminant 1; . . . ; and r(9) is the B value of reflectance under camera illuminant 3.

d_{A} is a column 10-vector, where d_{A}(1) is the X value of reflectance under display illuminant 1; d_{A}(2) is the Y value of reflectance under display illuminant 1; . . . ; d_{A}(9) the Z value of reflectance under display illuminant 3; and d_{A}(10)=1.

R_{T} is a 9×24 matrix, where R_{T}(1,1) is the R value of reflectance 1 under camera illuminant 1; R_{T}(1,2) is the R value of reflectance 2 under camera illuminant 1; R_{T}(2,1) is the G value of reflectance 1 under camera illuminant 1; and R_{T}(2,2) is the G value of reflectance 2 under camera illuminant 1.

D_{A} is a 9×24 matrix, where D_{A}(1,1) is the X value of reflectance 1 under display illuminant 1; D_{A}(1,2) is the X value of reflectance 2 under display illuminant 1; D_{A}(2,1) is the Y value of reflectance 1 under display illuminant 1; D_{A}(2,2) is the Y value of reflectance 2 under display illuminant 1; . . . ; D_{A}(9,24) is the Z value of reflectance 3 under display illuminant 3; D_{A}(10,1)=1; . . . ; and D_{A}(10,24)=1.

By way of overview and as a general introduction into the relationship between the above stated values and their associated algorithms, the values for a matrix (such as “9” in the 9×K matrix R_{T}) can be understood as follows: If N is the number of visible wavelengths chosen to define reflectances (say, N=31 wavelengths sampled from 400 to 700 nm in 10-nm steps), then R_{T} is the product of a 9×N matrix Q of three color-matching functions under three chosen illuminants (a total of 9), and an N×K matrix R_{0T} of estimated reflectances of the K reference reflectances.

Proof: Posing the reflectance-estimation problem as that of finding the N×9 matrix M₀ that maps (as closely as possible) all the reference camera values D to the corresponding reflectances, through best-fitting the relation

R_{0T}=M₀D. (1-1)

Given M₀, a new reflectance r′ can be estimated from its camera values d by

r′ₐ=M₀d. (1-2)

Note that the columns of M₀ are 9 reflectance-basis functions, and the column 9-vector d is a set of coefficients that linearly combine the basis functions to approximate r′. The matrix M₀ depends only on the calibration data and not on the test r′ or d.

Now apply the pseudo-inverse of D to the right of both sides of Eq. (1-1), and obtain:

M₀=R_{0T}D′(DD′)⁻¹, (1-3)

Which can now be applied to estimate a new reflectance from its camera values via Eq. (1-2).

Pre-multiplying Eq. 1-3 by Q to get 3 sets of 3 tristimulus values gives

QM₀=QR_{0T}D′(DD′)⁻¹, (1-4)

Defining M=Q M₀ and R_{T}=Q R_{0T}, we retrieve EQN 1 (with vector b=0). The generalization to nonzero b is straightforward. QED.

Hence the output 9-space of the above algorithm is selectable: one can choose any set of three illuminants multiplied by any sets of color-matching functions. One can even choose the illuminants in Q to be the same as the three spectra of light in the actual microscope. In fact, one can make the matrix Q from any number of functions, for example only one of the microscope illuminants multiplied by the three CIE color-matching functions. In that case, the matrix Q would have dimensions 3×L, and the matrix R_{T} would have dimensions 3×K.]

In the embodiments so far described the color calibration process does not require knowledge of the actual microscope light spectrum or the camera spectral sensitivities. In an alternative embodiment in the absence of this spectral sensitivity knowledge, the reference samples in the field of view of the imaging device are used to calibrate the color values. This is called in situ calibration. However, if the microscope light spectrum and the camera spectral sensitivities are accurately known, then physical reference samples are not required at all: Each of the i, j components of matrix R_{T} in EQN. 4 can in that case be computed by wavelength-integrating the product of each light spectra times each reference reflectance spectrum times each camera-sensitivity function. The matrix D_{A} is computed as before. This method is called non-in-situ calibration, which is usable when the light source, camera, and reference samples are very stable in time.

It is also important to understand how the present invention incorporates the adaptations of EQNs 1-3 to be used for an image of a fluorescent microscope, with fluorescent microspheres or quantum dots as reference targets. The calibration values in this case comprise a 3×K matrix D of (RGB) camera values from the calibration chart and a 3×K matrix R_{T} of tristimulus values from the same calibration chart, where K is the number of fluorescent reference targets. The matrix D from the calibration chart is measured by the camera under the same UV excitation, and at the same time, as is an image of fluorescent test targets (e.g., a fluorescent stained specimen). The matrix R_{T} is pre-computed from the emission-spectrum values pre-measured from the calibration chart, in conjunction with color matching functions and the known UV excitation.

To calibrate, a 3×3 matrix M (from camera RGB to tristimulus XYZ) and an offset vector b are computed so as to estimate the tristimulus 3-vector r of any fluorescent test target. The matrix M and offset vector b map (as closely as possible) all of the database camera value 3-vectors to corresponding tri-stimulus 3-vectors as follows:

R_{T}=MD+b (EQN. 1F)

EQN. 1F may be represented as a homogeneous equation as:

R_{T}=M_{A}D_{A} (EQN. 2F)

where M_{A}=[Mb] is the 9×10 matrix comprising M right-augmented by the column vector b, and D_{A}=[D′1′]' is the 10×9 matrix comprising D augmented from the bottom by a row K-vector 1 of 1's. Here, D′ is the transpose of D. To estimate M_{A}, the following least-square approximation is used:

M_{A}R_{T}pinv(D_{A})=R_{T}D_{A}′(D_{A}D_{A}′)⁻¹ (EQN. 3F)

In an alternative embodiment, a 3×K matrix stores the data for each illuminant handled separately. The 3×3 calibration matrix M is calculated separately for each illuminant, and each image is corrected using the corresponding M matrix.

Thus, multiple digital spectra of known illuminants are used, in conjunction with the acquired image RGB values, to compute the XYZ tristimulus values for a sample under the known illuminants. Then, if one wishes to display the same colors that are seen in the imaging booth 102, the spectra of the real illuminants (i.e., the illuminants under which the images of the sample are captured) are adjusted to match the digital spectra used to compute the XYZ tristimulus values. A series of filters or filtered images can be used to form a composite image that provides information regarding different transmission spectra. Through this compositing or filtering, the transmittance or reflectance spectrum at every pixel of the image, including pixels that contain reference images can be discerned. These pixels can be used to provide a spectral estimation of the relevant color values in the image. This image can be converted into a multi-stimulus values governed by a plurality of illuminating conditions.

As discussed above, the computer system 601 corrects the captured separate illumination images for light non-uniformity, using a uniform target at the site of the photography. For example, a grey color target. This process is well-known and involves scaling each pixel intensity to the mean pixel intensity in every image plane (R, G, B for each camera illuminant), image-by-image. This, combined with a database of reference spectrum values, allows the following algorithm to estimate the reflectance values under multiple lighting conditions and illuminants

For example, let P be any one of the camera R, G, B image channels for any of the plurality of camera illuminants. In addition, let P(i, j) be the ij pixel of the P image in the presence of test colors, and P₀(i, j) be the ij pixel of the P image in the presence of the color target. Then, for each of the nine P channels, the following steps are performed.

First, the image P₀(i, j) and its mean Pₘₑₐₙ is acquired for all i,j. Next, a correction array C(i, j)=Pₘₑₐₙ/P₀(i, j) is constructed. Then, the test color image P(i, j) is acquired. The corrected P image P_{corr}(i, j)=P(i, j)*C(i, j) is then constructed.

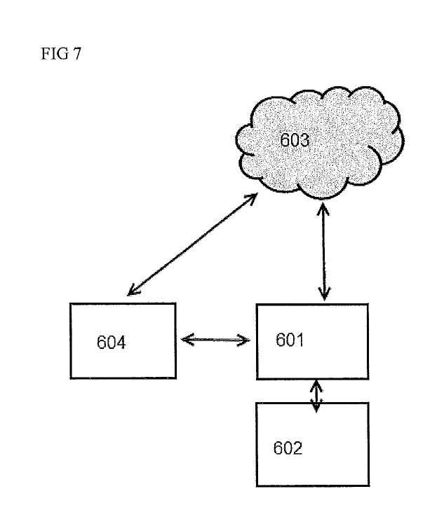

As shown in FIG. 7, the imaging of the slides can take place at an imaging site 604. The imaging site in this embodiment contains at least the magnification apparatus (i.e. microscope) and an imaging device such as a digital camera. The present invention is configured to transmit the tristimulus data directly to a local computer system 601 through physical or wireless connections. As an alternative embodiment of the present invention, it is possible to configure the tristimulus data to be transmitted to a remote processing computer system or cloud based computer system 603. For example, it is possible to transmit the tristimulus values from the imaging site to a local computer system which in turn offloads the processing duties to a cloud-based processing appliance. The local computer is further configured to possess a database wherein reference spectrum values are stored.

In the alternative, the imaging site, through a wireless connection can transmit the necessary data directly to a cloud based processing appliance. This reduces the need for complex computational hardware on site. Furthermore, this allows for specific calibration and maintenance issues to be performed on a centrally located computer and software system and ensures that there is less variance between users.

The imaging device can be any device capable of capturing the required spectral data in sufficient detail necessary for the calibration functions to proceed. For example, a digital still camera, digital motion picture camera, portable computer camera, desktop computer camera, PDA with equipped camera, imaging device equipped smart-phone, camera phone, web camera, and so on, having sufficient resolution for capturing color information, can be employed as the imaging device. Furthermore, any device may be used as an imaging device so long as it is capable of capturing optical data through a lens or plurality of lenses, and transmitting an image file that includes the captured data. As one non-limiting example, a digital single lens reflex camera and microscope adaptor are suitable image capture devices. Although the imaging device is represented herein as a single device, it is not limited to such, but instead can comprise a camera coupled to another system that enables image transfer over a network to the computing device 601.

Once the imaging processing has been completed, the color corrected image can be sent to the calibrated display device 602. The present invention can be configured so as to allow display devices, such as computer monitors and projection devices to be calibrated through external calibration systems such as Spyder® calibration device, or by using color information from the processed images themselves. In an alternative embodiment, the color corrected image is sent directly to a printer configured to accept the image file. In this embodiment a monitor is not necessary. The printer can be any standard or customized printing device.

It is further expected that the computer system 601 is fully capable of connecting to external and internal networks so as to distribute processing tasks or exchange data imbedded within each slide. The computer system can connect to networks and databases using commonly understood programming interfaces and interface modules, e.g., Media Server Pro, Java, Mysql, Apache, Ruby on Rails, and other similar application programming interfaces and database management solutions. The remote analysis system 603 of the present invention is characterized, in part, by its broad adaptability to user configurations, multiple user inputs, and hardware configurations.

The remote analysis system 603 can also accessed by way of a web portal, e-mail, or text message. The computing device is capable and configured to receive industry standard telecommunications for data transfer. Furthermore, the computing system is capable of parsing telephone, e-mail, and other header data so as to enable a return message to be sent to a user using conventional protocols as is commonly known (e.g., using the Automatic Number Identification (ANI) in a telephone call set-up, or sender address information in an email). The remote analysis system can be connected to in a conventional manner, such as by using a web browser program such as Mozilla's Firefox. The web portal offers the ability to transmit data from non-networked sources such as digital cameras, web camera, and digital tape feed.

The system of the present invention provides the user with access to color calibration functions as well as data functions associated with a particular integrated slide. This enables a user to identify specific information about the type of slide used. For example, if the slide contains a color target as opposed to quantum dots pallets. In this instance, the present invention will alter the processing of the images to reflect the physical conditions of the integrated slide. The computer system is configured to store and associate data about the integrated slide with images taken from that specific slide. This enables researchers and technicians to gain calibration and other technical data from slides that are no longer in use and have potentially been discarded.

The present invention also incorporates a methodology of using the system so described to carry out and achieve the function of providing a color calibrated image to a display. Such a method involves, but is not limited to, a securing step, wherein the object or sample is affixed to the integrated color target microscope slide. A recording step has a plurality of images of the integrated color target slide recorded under a plurality of differing lighting schemes and illuminations. An optional data collection step has data contained or imprinted within the integrated slide optically or electronically recorded and appended or otherwise combined with the plurality of recorded images. A calibration step, wherein the poly-stimulus values are used to estimate the proper color and reflectance characteristics of each pixel, uses the above referenced algorithm. An output step wherein a calibrated image is then provided in electronic file format ready for storage or transmittal to a display device. An optional monitor calibration step operates in the event that the calibrated image is to be displayed on an un-calibrated display device, by calibrating the display prior to displaying the image. The above processing functions can operating as a series of programmed steps preformed by a properly configured computer system using one or more modules of computer-executable code. For instance, a set of software modules can be configured to cooperate with one another to provide accurate reproduction of color information to a display device as described herein. In this regard, there can be an imaging module, a data collection module, a calibration module, and an output module.

The imaging module can be configured as a series of discrete sub-modules designed to access optical data from a digital image capture device and convert that data into a format suitable for individual pixel analysis. The imaging module incorporates functions enabling the present invention to record a set number of images, change illuminants, configure recording resolution and alter built-in or other color filters.

A data collection module can be configured as a series of discrete sub-modules designed to access the integral color target data located on the microscope slide, access reference color and illuminant data located in a remote access database, and record unique identifier information embedded within the slide.

The calibration module can be configured as a series of discrete sub-modules providing the present invention with the necessary functionality to extract color value data from the image pixels, compare extracted color values against a database of reference color values, and transform the extracted pixel color values to conform to reference values.

The output module can be configured as a series of discrete sub-modules designed to provide functionality to the present invention. The discrete sub-modules could include instructions for combining the transformed pixels into a composite image, transmitting images to a display device, formatting images for a particular display device and updating a database of reference images and stored images.

Each of these modules can comprise hardware, code executing in a processor, or both, that configures a machines such as the computing system 601 to implement the functionality described herein. The functionality of these modules can be combined or further separated, as understood by persons of ordinary skill in the art, in analogous implementations of embodiments of the invention.

It should be understood that various combination, alternatives and modifications of the present invention could be devised by those skilled in the art. The present invention is intended to embrace all such alternatives, modifications and variances that fall within the scope of the appended claims.

While the invention has been particularly shown and described with reference to a preferred embodiment thereof, it will be understood by those skilled in the art that various changes in form and details may be made therein without departing from the spirit and scope of the invention

I claim:

1. An apparatus for managing the color microscope images, comprising:
a microscope slide configured to have a plurality of known reference colors integral to the body of the slide;
at least one illumination source;
an image recording device, capable of recording a plurality of images of the slide and the integral reference colors, wherein the images are comprised of a pixel may, each pixel having a color value;
an image processor, configured by code executing therein, to:
extract color value information from the pixel array of each of the plurality of images;
transform each the color value of each pixels to conform to reference color values; and
output a composite image wherein the color values of each pixel have been transformed based on the reference color values.

2. An apparatus for managing the color microscope images as in claim 1, wherein the illumination sources have at least one filter interspaced between the illumination source and the microscope slide.

3. An apparatus for managing the color microscope images as in claim 1, wherein the illumination sources have at least one filter interspaced between the microscope slide and the image recording device.

4. An apparatus for managing color microscope images, comprising:
a microscope slide configured to have a plurality of known reference colors integral to the body of the slide;
at least one illumination source;
a camera capable of recording a plurality of images of the slide and the integral reference colors, wherein the images are comprised of a pixel array, each pixel having a color value;
an image processor, configured by code executing therein, to:
extract color value information from the pixel array of each of the plurality of images;
transform each the color value of each pixels to conform to reference color values; and
output a composite image wherein the color values of each pixel have been transformed based on the reference color values; and
an output device configured to output the composite image generated by the image processor to a user.

5. An apparatus for managing the color microscope images as in claim 1, wherein the output device is a visual display device.

6. A method for managing the color on microscope images comprising:
securing a sample to a microscope slide, wherein the microscope slide includes an integrated color palette;
recording a plurality of images of the microscope slide that encompasses both the sample and the reference color pallet under a plurality of lighting conditions or one multiply filtered illumination source;
extracting from the plurality of images data points relating to color values of individual image pixels;
calibrating the data points to conform to reference values;
transforming the pixels to reproduce a corrected image with calibrated color values;
outputting the corrected image to a display device or storage medium.
